(19) United States
(12) Patent Application Publication
(10) Pub. No.: US 2007/0221335 A1
(43) Pub. Date: Sep. 27, 2007

(54) Device for contact by adhesion to a glass or semiconductor plate (wafer) surface or the like and system for gripping such a plate comprising such a device

(75) Inventors: Florent Haddad, Seilh (FR); Alain Gaudon, Launac (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Recif Technologies, Rue Aristide Berges (FR)

(21) Appl. No.: 11/389,559

(22) Filed: Mar. 23, 2006

(51) Int. Cl. B29C 65/00

(52) U.S. Cl. 156/539

(57) ABSTRACT

A device for contact by adhesion to a glass or semiconductor plate (wafer) surface or the like is disclosed. The device includes a base including a flexible material equipped with an adhesive contact surface intended to be attached to said plate surface by adhesion, and means for differentiating the separation resistance between said adhesive contact surface made of the flexible material and the surface of the plate, in a direction perpendicular to the adhesive contact surface and in a direction parallel to said adhesive contact surface.

### CROSS-REFERENCES TO RELATED APPLICATIONS

Not Applicable

### BACKGROUND OF THE INVENTION

This invention relates to the field of gripping and handling glass or semiconductor plates (wafer) or the like, in particular in processes for manufacturing these plates, in particular in the field of robots for gripping and/or moving these plates. A plurality of robots for gripping glass or semiconductor plates (wafer) or the like, using various plate-grasping techniques, are currently known.

In particular, engagement of the rear surface of the plate with a system generating a vacuum so as to hold the plate by suction is known.

Engagement by gravity on the edges of the plate is also known.

A forced engagement system on the edges of the plate between a mobile finger exerting pressure on the edge of the plate and fixed bearings is also known.

These systems function perfectly, but have several disadvantages, a primary one being contamination of the plates.

A system that significantly reduces the risks of contamination, consisting of gripping a plate by its rear surface, by contact, bearing, and adhesion thereof on pads made of a flexible material, for example a polymer, using a complete elastic bond by dry adhesion, obtained by means of Van der Waals forces, could be used. A disadvantage of this technique is that once the plate has been gripped, it is difficult to detach the pads thereof in order to release the plate from the arm supporting it.

### BRIEF SUMMARY OF THE INVENTION

This invention proposes a way in which to overcome these disadvantages, and to provide additional advantages. More specifically, it consists of a device for contact by adhesion to a glass or semiconductor plate (wafer) surface or the like, comprising:

a base including a flexible material equipped with an adhesive contact surface intended to be attached to said surface by adhesion, and

means for differentiating the separation resistance between said adhesive contact surface of the flexible material and the plate surface, in a direction perpendicular to the adhesive contact surface and in a direction parallel to said adhesive contact surface.

The applicant has observed that the main movements or accelerations of a plate, when it is gripped and moved by a robot arm, generating significant biases at the adhesive interfaces between the robot and the plate, are essentially parallel to the plane of the plate. This requires good adhesion of the flexible material in this plane, by shear force, while to move and release a plate, the separation occurs in the direction perpendicular to the plane of the plate, which requires low adhesion in this direction so as to facilitate this separation operation. On the basis of such observations and analyses, the applicant had the idea of improving the single massive contact pad made of a flexible material so as to give it clear adhesive capabilities, differentiated in certain directions. The means for differentiating the separation resistance between said adhesive contact surface made of a flexible material and the plate surface, in a direction perpendicular to the adhesive contact surface and in a direction parallel to said adhesive contact surface, or tangential thereto, allow for a good capacity of the flexible material to adhere to the plate in a complete adhesion bond, which is elastic owing to the flexibility of the contact material, without being subject to the disadvantages caused by the difficulty of separating the plate from the flexible material when this plate is to be released. Thus, the separation resistance, which is expressed by a force, can have different values according to the direction perpendicular to the contact surface and according to the direction parallel to this contact surface for the same given contact surface. In the present invention, “flexible material” means any flexible material by nature, such as a flexible polymer, or any material made flexible by geometry, such as a semiconductor or a steel material, for example formed as a very thin layer and/or including a microstructure on its contact surface, particularly a fibrillated or laminate microstructure.

According to an advantageous feature of the device according to the invention, the means for differentiating the separation resistance between said adhesive contact surface made of a flexible material and the plate surface, in a direction perpendicular to the adhesive contact surface and in a direction parallel to said adhesive contact surface, include:

means for conferring on the base stiffness or capacity for elastic extension, in the direction perpendicular to the adhesive contact surface, differentiated on the width of the base.

This feature allows for a gradual separation of the adhesive surfaces in contact, i.e. a separation that starts at a small portion of the surface in contact, therefore requiring little force, then gradually extending to the entire surface, therefore still requiring little force, under the effect of a force causing the surfaces to separate in a perpendicular direction, maintained for the entire duration of the separation of the surfaces in contact.

According to an advantageous feature of the device according to the invention, the separation resistance between said adhesive contact surface and the plate surface, in a direction perpendicular to the adhesive contact surface, is lower than the separation resistance between said adhesive contact surface and the plate in a direction parallel to said adhesive contact surface.

This feature favors one direction over the other, namely the direction perpendicular to the adhesive contact surface, so as to facilitate the separation between the plate and the flexible material. It should be noted that other directions for facilitating the separation can be favored, as needed, more specifically in the directions of movement and accelerations of the plates caused by the robot using the contact device according to the invention.

According to an advantageous feature of the device according to the invention, said means for differentiating the separation resistance between the adhesive contact surface and the plate surface, in a direction perpendicular to the adhesive contact surface, and in a direction parallel to said adhesive contact surface, include:

a rigid material secured to the flexible material, forming therewith a base having a uniform or substantially uniform thickness, and defining a different thickness of the flexible material for the width of said base or at least a portion thereof.

A rigid/flexible bimaterial structure of the base, conferring a different thickness of the flexible material in particular on the width of the base, makes it possible to provide a vertical stiffness of the base that is different at various points thereof. The separation between the adhesive surface of the flexible material and the plate surface will begin in the stiffest place, i.e. where the flexible material has a smaller thickness and therefore where the base has a minimum elastic extension capacity. Thus the separation of the surface occurs gradually, first in a small portion of the surface, then gradually extending to the entire surface, thus making it unnecessary to exert a significant force which would be necessary if the entire surface were to be separated simultaneously. The effect achieved in the separation is a “peeling” effect, generating a minimal force. The area of the surface of the flexible material attached to the plate can be determined according to the need for adhesion resistance of the surface under the shear force, according to the tangential force on the maximum surface to which the adhesion bond is subjected, and the distribution of the flexible/rigid material of the base, determining the separation resistance in the direction normal to the adhesive surface can be determined according to the need for adhesion resistance of this surface in a direction normal thereto.

According to an advantageous feature of the device according to the invention, the thickness of the flexible material gradually and continuously increases over the width of said base or at least a portion thereof.

Such a feature provides a continuous and regular progression of the separation between the surface and the plate.

According to an advantageous feature of the device according to the invention, the rigid material adopts a cylindrical shape comprising a biased end, and the flexible material is attached to the rigid material by said biased end and adopts a complementary shape so as to confer a right cylinder assembly form on the base.

According to an advantageous feature of the device according to the invention, the rigid material has a conical shape integrated in the flexible material.

According to an advantageous feature of the device according to the invention, the rigid material adopts a shape comprising a conical recess in which the flexible material having a complementary conical shape is integrated.

According to an advantageous feature of the device according to the invention, the flexible material constitutes the base, in which said means for differentiating the separation resistance between the adhesive contact surface and the plate surface in a direction perpendicular to the adhesive contact surface and in a direction parallel to said adhesive contact surface includes at least one transverse slot in the base, extending over at least a portion of the cross-section of the flexible material.

This feature presents an alternative to a bimaterial base as defined above, by conferring, on the flexible material forming the base, different extension capabilities over the width of said base. Thus, the surface will begin to separate from the plate where the cross-section is not slit, such a location being the least expandable of the base, and will eventually become separated in the location farthest from the zone where the cross-section was not slit, this location being that which has the greatest capacity for pulling away among the portions of the material separated by the slot.

According to an advantageous feature of the device according to the invention, said at least one transverse slot of the base, extends over at least a portion of the transverse cross-section of the flexible material so as to confer a U-structure on the base.

According to an advantageous feature of the device according to the invention, the base includes two opposing transverse slots, extending over at least a portion of the cross-section of the flexible material, at two different heights thereof so as to confer a flexible Z-structure on the base.

Such a structure of the base allows for a degree of freedom of the bond in a direction perpendicular to the contact surface made of the flexible material, wherein the flexible Z-shaped material is capable of unfolding before beginning to separate from the plate; then, once the Z is unfolded, the separation will occur first in the location where the base is least expandable, that is on the side where the upper bar of the Z is attached to the transverse bar of the latter.

According to an advantageous feature of the device according to the invention, the base takes the form of a flexible material layer in which a spiral cross sectional slot is formed, providing a spiral flexible material layer the center of which being attached to a support.

According to an advantageous feature of the device according to the invention, said means for differentiating the separation resistance between the adhesive contact surface and the plate surface, in a direction perpendicular to the adhesion contact surface, and in a direction parallel to said adhesive contact surface, include:

a flexible plate intended to be attached to a rigid support capable of supporting said glass or semiconductor plate (wafer) or the like, on a surface and to an end of which the flexible material is attached, wherein the flexible material forms said base of which a first end constitutes said adhesive contact surface, and of which the other end opposite the first end constitutes a surface for bonding to the flexible plate.

This feature makes it possible to obtain “peeling” effects during the separation, comparable to those of a base made of a flexible slit material, wherein the function of the slot is in this case obtained by means of an elastic movement of the flexible plate, for example, obtained in a hard material. An advantage that can be conferred by the flexible plate is that of providing a complete elastic bond of which the elastic return force of the surface in rest position, which is substantially significant, is determined according to requirements independently of the nature of the flexible contact material, and also of providing a complete elastic bond of which the elastic extension length is greater than that of the flexible material.

According to an advantageous feature of the device according to the invention, said means for differentiating the separation resistance between the adhesive contact surface and the plate surface, in a direction perpendicular to the adhesion contact surface, and in a direction parallel to said adhesive contact surface, include:

a rigid support capable of supporting said glass or semiconductor plate (wafer) or the like, on a surface and to an end of which the flexible material is attached, wherein the flexible material forming a base of which a first end constitutes said adhesive contact surface, and of which the other end opposite the first end includes an annular surface for bonding to the rigid support, the flexible material adopting a deformable elastic membrane form,

the rigid material comprising a line for supplying pressurized fluid leading to the annular bonding surface,

means for supplying the line with pressurized fluid, so as to confer at least two distinct positions on the deformable membrane:
a first so-called adhesion position, in the absence of a pressurized fluid supply to the deformable membrane, in which the separation resistance between said adhesive contact surface and the plate surface in a direction parallel to said adhesive contact surface is maximal,
a second so-called separation position, in the presence of a pressurized fluid supply to the deformable membrane, in which the separation resistance between said adhesive contact surface and the plate surface in a direction perpendicular to the adhesive contact surface is minimal.

This feature makes it possible, with a single flexible membrane, and a fluid supply that is pressurized, for example, by compressed air, to obtain an excellent adhesive bond by shear force (according to forces tangential to the contact surface), as well as an excellent bond in the direction perpendicular to said contact surface, while allowing for an easy separation of the plate. Indeed, by means of a simple deformation of the flexible membrane under the effect of a fluid injection, said membrane is deformed so as to minimize the adhesive contact surface area, and thus minimize the force needed to separate the plate from the surface thus reduced. In addition, the deformation of the membrane in order to facilitate the separation of the adhesive bond causes a small movement of the plate which can advantageously be used as a replacement for the corresponding small movement of a robot that holds the plate with a gripping arm advantageously equipped with contact devices according to the invention. These small movements caused by the deformation of the flexible membrane can be controlled, for example, by controlling the fluid injection pressure on one side of the membrane.

According to an advantageous feature of the device according to the invention, said adhesive contact surface made of the flexible material includes a fibrillated or laminate microstructure, increasing the adhesive force.

Such a specific contact surface enables the adhesive forces generated by the surfaces implemented to be improved, by increasing the intensity of the Van de Waals contact forces. This known technique is based on the analysis of adhesive forces enabling an animal called a Gecko to stay and move on smooth vertical surfaces. Such a specific contact surface further enables to reduce the contact contamination of the glass or semiconductor plate (wafer) or the like, and also reduce the accumulation of dirt on such a surface.

According to an advantageous feature of the device according to the invention, said adhesive contact surface consists of a porous or microporous material allowing the passage of a gaseous fluid therethrough.

This feature makes it possible for a gaseous fluid to pass through the flexible material, at least through the adhesive contact surface, by generating a fluidic suction through said flexible material in order to advantageously suck in contaminant particles which would be in the contact area between the flexible material and the semiconductor plate (wafer), preferably before the contact between the flexible material and the plate. The device for contact by adhesion according to the invention thus allows to reduce the risks of contamination of the glass or semi-conductor plate.

The invention also relates to a system for gripping a glass or semiconductor plate (wafer) or the like, including:

a rigid arm for gripping the glass or semiconductor plate (wafer) or the like, equipped with a plurality of degrees of freedom of movement,

at least three devices for adhesive contact with a surface of the glass or semiconductor plate (wafer) or the like, connected to said gripping arm.

This feature proposes a known robot-type system for moving semiconductor plates, for example, comprising an arm for gripping plates equipped with six degrees of freedom in space, to which at least three contact devices according to the invention as defined above, have been connected, thus enabling a minimum isostatic equilibrium of the plate to be ensured. Such a system according to the invention can comprise a gripping arm provided with means for turning the plates about an axis perpendicular to the plane of the plates, wherein the interfaces of the system with the plate are provided by contact devices according to the invention.

### BRIEF DESCRIPTION OF THE DRAWINGS

The invention can be better understood, and other features and advantages will be clear from the following description of several embodiments of a device for adhesive contact with a glass or semiconductor plate (wafer) surface or the like, and a system according to the invention for gripping a glass or semiconductor plate (wafer) or the like, with appended drawings in which:

FIG. 1 shows a cross-section view of a first embodiment of a contact device according to the invention;

FIG. 2 shows a cross-section view of a second embodiment of a contact device according to the invention;

FIG. 3 shows a cross-section view of a third embodiment of a contact device according to the invention;

FIG. 4 shows a cross-section view of a fourth embodiment of a contact device according to the invention;

FIG. 5 shows a cross-section view of a fifth embodiment of a contact device according to the invention;

FIG. 6 shows a cross-section view of a sixth embodiment of a contact device according to the invention;

FIGS. 7A to 7D show a cross-section view of a seventh embodiment of a contact device according to the invention, in various positions thereof;

FIG. 8 shows a cross-section view of an eighth embodiment of a contact device according to the invention.

FIG. 9 shows a cross-section of a flexible material.

FIGS. 10-11 also show cross-sections of flexible materials.

### DETAILED DESCRIPTION OF THE INVENTION

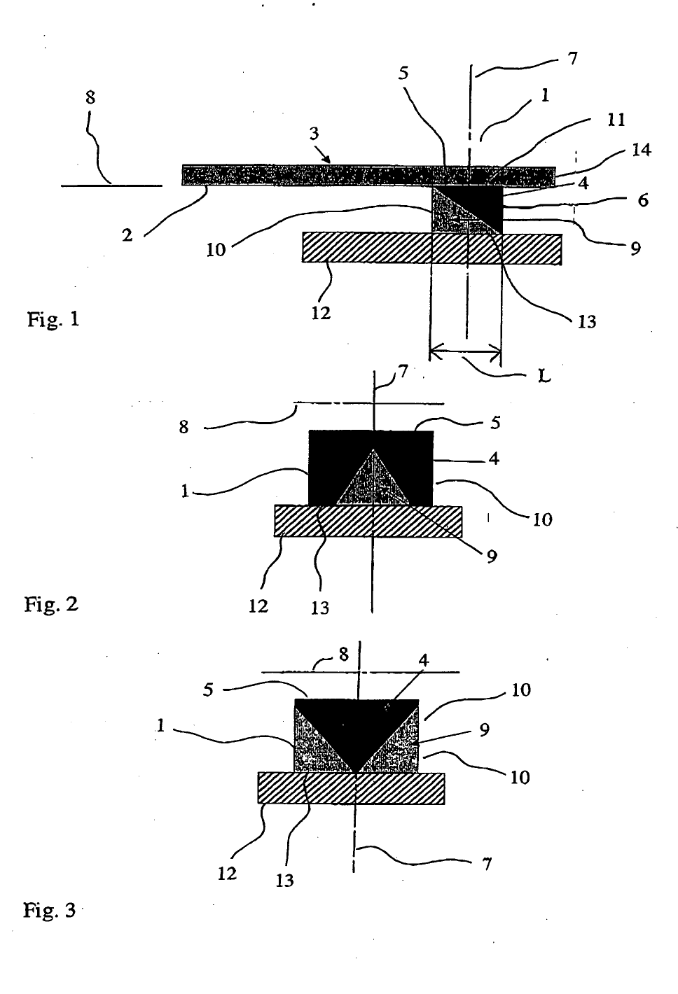

Referring to FIG. 1, the device 1 for adhesive contact to a glass or semiconductor plate 3 (wafer) surface 2 or the like, comprises:

a base 10 including a flexible material 4 equipped with an adhesive contact surface 5 intended to be attached to the surface 2 by adhesion,

means 6 for differentiating the separation resistance between the adhesive contact surface 5 made of the flexible material 4 and the surface 2 of the plate 3, in a direction 7 perpendicular to the adhesive contact surface 5 and in a direction 8 parallel to the adhesive contact surface 5, wherein said means 6 advantageously comprise a rigid material 9 secured to the flexible material 4, forming a base 10 therewith, advantageously having a uniform or substantially uniform thickness, and defining a different thickness of the flexible material 4 for the width L of the base 10 or at least a portion thereof.

The base 10 adopts, for example, a right cylinder shape with a uniform thickness, in which the thickness of the flexible material gradually and continuously increases over the width of the base. The rigid material 9 adopts, for example, a general wedge shape, for example a cylindrical shape comprising a biased end 11, and the flexible material 4 is attached to the rigid material 9 by the biased end 11 and adopts a complementary shape so as to confer on the base a right cylinder assembly shape of uniform thickness.

The rigid material 9 can be silicon, silicon oxide, a stainless steel, or aluminum, for compatibility or affinity with a semiconductor plate, and the flexible, or preferably very flexible material 4 can be a polyurethane or silicone-type polymer, such as a PDMS silicone. The combination of the flexible or very flexible material and the rigid material can be achieved by means of entirely known techniques, such as bonding, grafting, and so on.

In the example shown in FIG. 1, the rigid material 9 should preferably not come into contact with the surface 2 of the plate 3, and, therefore, a relatively thin flexible material 4 can be provided above the portion of rigid material 9 that is highest in FIG. 1, or intended to be closest to the plate.

The two end surfaces of the base 10 thus formed, denoted by reference 5 for the surface in contact with the plate and 13 for the surface bound to the support 12, are advantageously parallel so as to allow for a rigid bonding support 12 of the base 10 to a robot arm or the like intended to grip the plate and/or move it in space, parallel to the plane of the plate 3. The plates 3 are generally, but not exclusively, silicon plate with a circular outer edge 14, in the shape of a disk or a plate.

Thus, in the example of FIG. 1, the adhesive contact surface 5 has an area equal to the transverse cross-section of the base, but a progressive thickness from one side to the other of the width L of the base 10, which corresponds to a diameter in the case of a base with a circular cross-section, for example. Therefore, the extension capacity of the base 10 in the direction 7 perpendicular to the plate 3, essentially due to the flexible material 4, because indeed that of the rigid material 9 is relatively insignificant, is progressive from one end of the diameter of the base 10 to the other. Thus, when there is a force in the direction 7 causing surface 5 to be separated from the plate surface 2, the portion of the base with the lowest extension capacity will separate first, thus reducing the area of the surface separated to a small zone thereof, then the separation will gradually occur, as a separation force is maintained, toward the zone of the base 10 at the maximum thickness of the flexible material 4. Thus, the complete separation will have been gradual, thus requiring less force than if it were necessary to simultaneously separate the entire surface in contact.

The means 6 thus enable a stiffness or capacity for elastic extension to be conferred on the base 10, in a direction 7 perpendicular to the adhesive contact surface 5, differentiated over the width of the base 10, in order to facilitate the separation of surface 5 from surface 2 of the plate 3 in this direction, by means of a gradual separation of the surfaces.

According to the invention, this difference in elastic extension capacity of the base 10 over its width or a portion thereof makes it possible to obtain a separation resistance between the adhesive contact surface 5 and the surface 2 of the plate 3, in a direction 7 perpendicular to the surface 5, different from, and advantageously lower than, the separation resistance between this surface 5 and the plate in a direction parallel to the adhesive contact surface 5.

FIG. 2 is an alternative to FIG. 1, in which the function elements identical to those of FIG. 1 are shown with the same numerical references. The device of FIG. 2 differs from that of FIG. 1 in that the flexible material 4 adopts a cylindrical or prismatic shape, for example, comprising two opposing, parallel surfaces 5, 13, and the rigid material 9 adopts a circular or prismatic conical shape integrated in the flexible material 4, so that the base of the conical shape of the rigid material constitutes a portion of the surface 13 attached to the support 12, and the remaining portion of this surface 13 is constituted by the flexible material, so that the axes of symmetry of the flexible material 4 and the rigid material 9 are, for example, aligned in the vertical direction 7, as shown in FIG. 2. Thus, the contact surface 5 will first separate from the center of the base 10 at the vertical of the apex of the rigid conical portion, then the separation will gradually extend radially toward the exterior edges of the base.

FIG. 3 is an alternative to FIG. 2, in which the function elements identical to those of FIG. 2 or 1 are shown with the same numerical references. The device of FIG. 3 differs from that of FIG. 2 in that the flexible material 4 adopts a conical shape with a circular base or a prismatic shape for example, of which the base constitutes the adhesive contact surface 5, and in that the rigid material 9 adopts a hollow shape comprising, at one end, a central conical recess complementary to the shape of the flexible material 4 so as to house the latter in the recess, and, at the opposite end, a surface 13 attached to the support 12, wherein the axes of symmetry of the flexible material 4 and the rigid material 9 are, for example, and where appropriate, aligned in the vertical direction 7, as shown in FIG. 3. Thus, conversely to the example of FIG. 2, the contact surface 5 will first separate from the exterior edges of the base 10 where the thickness of the flexible material is lowest, then the separation will gradually extend radially toward the center of the base 10 to the vertical of the apex of the flexible conical portion. The surface 5 and 13 are advantageously parallel, and the flexible material 4 is attached to the rigid material 9 using any means known, for example by bonding or grafting.

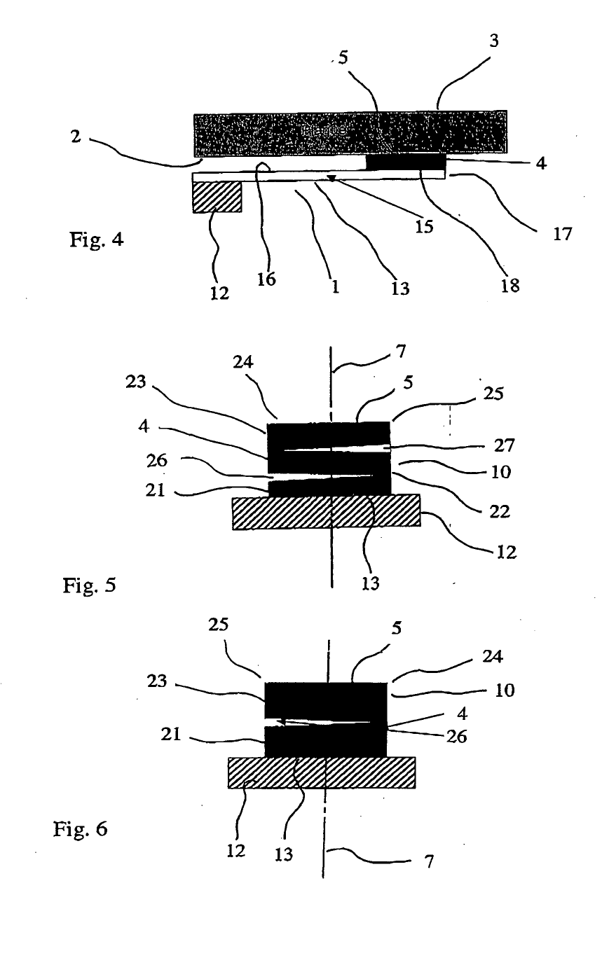

The device shown in FIG. 4 is an alternative to the device according to FIG. 1, in which the function elements identical to those of FIG. 1 are shown with the same numerical references. The device of FIG. 4 differs from that of FIG. 1 in that it includes a flexible plate 15 intended to be attached to a rigid support 12 capable of supporting the glass or semiconductor plate (wafer) or the like, on a surface 16 and to an end 17 of which the flexible material 4 is attached, wherein the latter forms a base 10 of which a first end constitutes the adhesive contact surface 5, and of which the other end opposite the first constitutes a surface 18 for bonding to the flexible plate 15. The device is attached to the rigid support 12 by the other surface 13 of the flexible plate 15, as shown in the figure. The base 10 is thus constituted solely of the flexible material of which the opposing surfaces 5 and 18 are, for example, parallel, and the effect of differentiating the stiffness over the width of the base 10 is obtained by the flexibility of the plate 15, to the end of which the base 10 is attached, and to the other end of which the support 12 is attached. The flexibility of the plate 15 and the resulting bending distortion confer a stiffness on the device, when the support 12 moves in the direction perpendicular to the surface 2 of the plate 3 and perpendicular to the plane of the elastic plate, which stiffness is greater in the zone closest to the attachment of the plate 15 to the support 12 where the edge of the base 10 is located, than in the end zone of the plate 15 where the opposite edge of the base 10 is located. The effect obtained is similar to that of the examples of FIGS. 1 to 3, but the fourth example allows for a relative elastic movement of the plate 2 with respect to the support 12 conferred by the elasticity of the plate 15, greater than that of the examples of FIGS. 1 to 3, while providing a good adhesion bond throughout this movement. Such elasticity can, for example, be used to counteract the forces of inertia on the adhesive contact surface 5, which are normal thereto, when the plate moves.

The device shown in FIG. 5 is another embodiment of a device according to the invention, in which the function elements identical to those of FIG. 1 are shown with the same numerical references.

The device of FIG. 5 includes a base 10 made of the flexible material 4, having a constant or substantially constant thickness. The means 6 include two opposing transverse slots 26, 27 of the base 10, extending over at least a portion of the cross-section of the flexible material, at two heights which are different therefrom so as to confer on the base a flexible Z-structure, as shown in FIG. 5. The base 10 can, for example, adopt a right cylindrical shape comprising upper 5 and lower 13 planar and parallel surfaces, and the two slots are respectively formed so as to separate the height of the base 10 into three stacked portions 21, 22, 23 of substantially equal thicknesses, wherein two successive portions are mutually attached by a cross-section of unslit flexible material, as shown in FIG. 5. Thus the upper edge 24 of the base 10, that is, of the contact surface 5, has an elastic extension capacity that is lower at the diametrically opposite upper edge 25 of the base 10, causing a peeling effect, that is, a separation first of the edge 24 when a separation force in the direction 7 perpendicular to the surface 5 is applied, then a gradual separation of the entire surface 5 to the farthest edge 25 of the support 12 in the maximum extension position of the base 10. In the maximum elastic extension position of the base 10 (not shown), it is noted that the surface 5 continuously and regularly becomes separated from the support 12, starting at edge 24 and going to the diametrically opposing edge 25.

The device shown in FIG. 6 is an alternative to that shown in FIG. 5. The function elements identical to those of FIG. 5 are shown with the same numerical references. The device of FIG. 6 differs from that of FIG. 5 in that the base 10 includes a single transverse slot 26, extending over at least a portion of the cross-section of the flexible material 4 so as to confer a U-structure on the base. The same effects as in the device of FIG. 5 are obtained, but with a lower extension capacity of the base 10.

In the spirit of FIGS. 5 and 6, the base may for example take the form of a flexible material layer, such as a disc, in which a spiral cross sectional slot (not shown) would be formed, providing a spiral flexible material layer the center (the inner end of the spiral) of which should be attached to a support for example the rigid support 12 above described. So, when the base is separated from the wafer, the center of the spiral layer will be first separated; then, the remaining base will be progressively separated, in a similar manner to a cord spirally winded on the plate which would be progressively separated from such plate due to the “peeling” effect, finally ending with the separation of the free and opposite end of the cord. The elasticity of the flexible material should lead, after separation, to a return of the base on the rigid support into its initial spiral form.

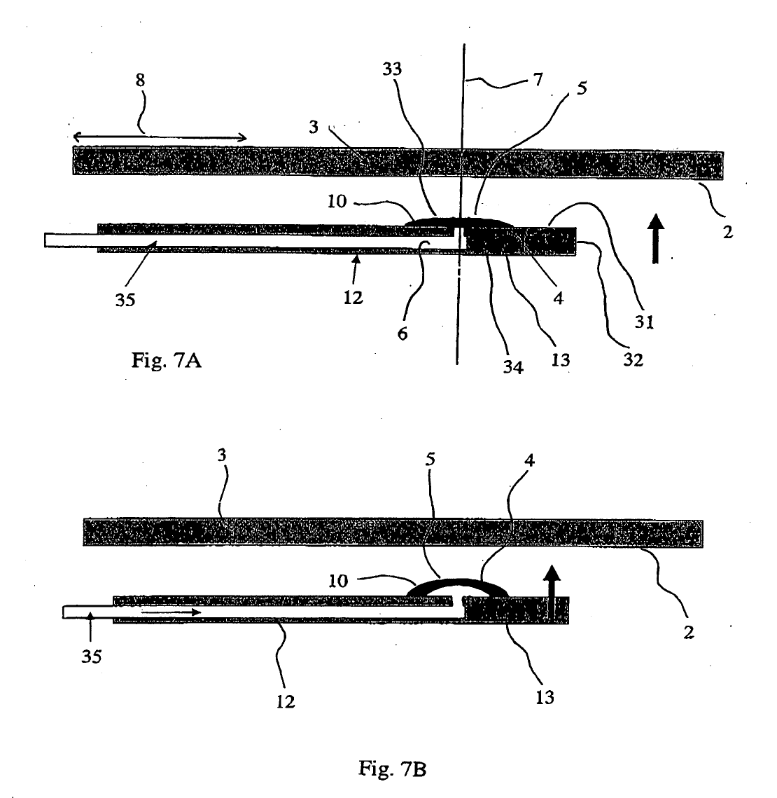

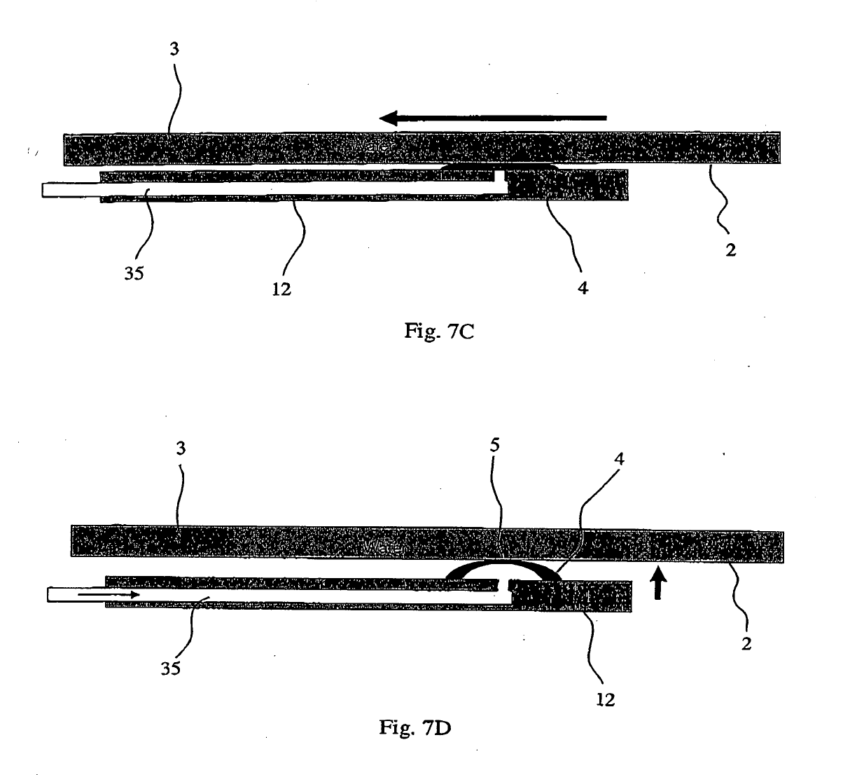

The device shown in FIGS. 7A to 7D is another embodiment of a device according to the invention in which the function elements identical to those of FIG. 1 are shown with the same numerical references.

In the device shown in FIG. 7, the means 6 for differentiating the separation resistance between the adhesive contact surface 5 and the surface 2 of the plate 3, in a direction perpendicular 7 to the adhesive contact surface 5, and in a direction parallel 8 to the surface 5, include:

a rigid support 12 capable of supporting the glass or semiconductor plate 3 (wafer) or the like, on a surface 31 and to an end 32 of which the flexible material 4 is attached, the flexible material 4 forming a base 10 of which a first end 33 constitutes the adhesive contact surface 5, and of which the other end 34 opposite the first includes an annular surface 13 for bonding to the rigid support 12, the flexible material 4 adopting a deformable elastic membrane form,

the rigid support 12 comprising a line 35 for supplying pressurized fluid leading to the annular bonding surface 13,

means (not shown) for supplying the line 35 with pressurized fluid, so as to confer at least two distinct positions on the deformable membrane 4, as shown in FIGS. 7A and 7B, or 7C and 7D, respectively:

a first so-called adhesion position (FIG. 7A or 7C), in the absence of a pressurized fluid supply to the deformable membrane 4, or in the presence of a suction through the line 35, that is, a depressurizing of the membrane, in which the separation resistance between said adhesive contact surface 5 and the surface 2 of the plate 3 in a direction 8 parallel to said adhesive contact surface 5, is maximal,

a second so-called separation position (FIG. 7B or 7D), in the presence of a pressurized fluid supply to the deformable membrane 4, in which the separation resistance between said adhesive contact surface 5 and the surface 2 of the plate 3 in a direction 7 perpendicular to the adhesive contact surface 5 is minimal.

The elastic membrane 4 can, for example, adopt the shape of a disk attached to the periphery of the surface 13 in contact with the rigid support, via a connection impervious to the pressurized fluid, by any means known, for example, by bonding or grafting, so as to leave a central portion of the surface 13 free, where the pressurized fluid line is to lead, as shown in FIG. 7B or 7D. The pressurized fluid sent through the line 35 causes the deformable elastic membrane to swell until it has a dome shape as shown in FIG. 7B or 7D, allowing for restricted contact of the surface 5 with the plate 3, as shown in FIG. 7D. The membrane and the pressure will be selected so as to obtain an adequate deformation of the membrane in order to form a dome in the elastic range of the flexible material 4. Adequate deformation in this case refers to a deformation that, when the plate 3 is in contact with the base 10, causes the adhesive contact surface 5 to gradually separate, beginning at the peripheral edge of the membrane 4, connected to the support 12, which has a minimum elastic extension capacity. It should be noted that the maximum elastic extension capacity is located at the center of the disk-shaped membrane, which is the point farthest from the support when the pressurized fluid is injected via the line 35. Thus:
when no pressurized fluid is sent through the line 35, the disk 4 is flattened against the rigid support 12 and the entire upper surface 5 of the disk 4 is in contact with the plate 3, thus allowing for maximum shear force adhesion in direction 8 as well as maximum adhesion in direction 7, and

when a pressurized fluid is sent through the line 35, it causes the contact surface 5 to gradually separate, thus reducing the force needed for separation of the contact surface 5 from the plate 3.

This seventh embodiment of the device according to the invention advantageously makes it possible, by allowing a central contact portion to remain at the apex of the dome when the fluid is sent under maximum pressure, whereof the surface can be controlled with the value of the injected fluid pressure, to simultaneously provide minimum adhesion in direction 8 and in direction 7, for example for small movements of the arm 12 supporting the plate.

In addition, this seventh embodiment of the device according to the invention advantageously makes it possible to use the movement of the plate due to the swelling of the membrane, such as a small movement capable of replacing a movement of the rigid support 12 which bears the plate 3, in direction 7.

The device of FIG. 7 functions, for example, in the following way:

the support 12 bearing, for example, three bases 10 distributed so as to statically support a plate 3, and which can be supplied with pressurized fluid, is brought close to the rear surface 2 of a plate 3 which is to be gripped and moved, without any fluid being injected into the bases 10,

before the contact with the plate, a fluid is optionally injected at a predetermined pressure, greater than ambient pressure of the plate, into the bases so that each base forms a dome capable of forming a contact buffer,

the gripping of the plate with bases having a contact surface thus reduced, can be used for small movements of the plate not requiring a significant adhesive force,

the removal of the pressure under the bases 10 when a plate is in place on said bases, enables the membranes to return to their initial contact form by means of elastic return, and thus the contact surface to be increased, and consequently the adhesive force to be increased, which is useful for high accelerations and rapid movements of the support 12,

to separate the bases 10 and therefore the rigid support 12 from the plate 3, a pressurized fluid is again injected into the line 35, gradually separating the adhesive contact surface 5 by deformation of the membrane 4, enabling the complete separation to be performed with minimal force exerted on the support 12 in direction 7 due to the minimum reduction of the adhesive contact surface.

It should be noted that, if the line 35 is not supplied with pressurized fluid, the annular shape of the attachment of the membrane to the support 12 and the elastic nature of the material forming the membrane enable the latter to retain a greater elastic extension capacity at the center of the disk than at the edge of the disk which is attached to the support. Thus, in the absence of any pressurized fluid supply, the shape of the attachment of the membrane enables the base to have a stiffness or elastic extension capacity, in the direction perpendicular to the adhesive contact surface, differentiated over the width of the base. The pressurized fluid supply enables the surface in contact with the plate to be guided or controlled.

The flexible material 4 shown on FIGS. 1 to 11 may consist of a porous or microporous material in order to allow a gaseous flow through the adhesive contact surface 5, with the aim of sucking in contaminant particles, advantageously in view of removing said particles from the contact surface 5 of the plate before a contact with the flexible material 4. A suction device which could be used for this purpose is a suction device similar to that described referring to FIGS. 7A to 7D, which may be applied to all embodiments of the invention shown in the figures of the present specification. A desirable feature is that the adhesive contact surface 5 has a microporous character on its entire surface in order to create a suction on the whole surface which is intended to contact the plate, and advantageously further in order to create a suction on a proximate area around the same. The fluidic suction through the flexible material 4 will be for example carried out during a definite lapse of time before contact, sufficient to suck in contaminant particles, and will then be stopped for example after contact or during contact. The porous or microporous flexible material can be obtained by any known means, for example as the result of the porous or microporous nature of said flexible material 4, or using a laser type processing of the flexible material, or due to a molding process of the same, or other. The porous or microporous flexible material may consist of a polymer as explained above, or of silicon as explained hereunder.

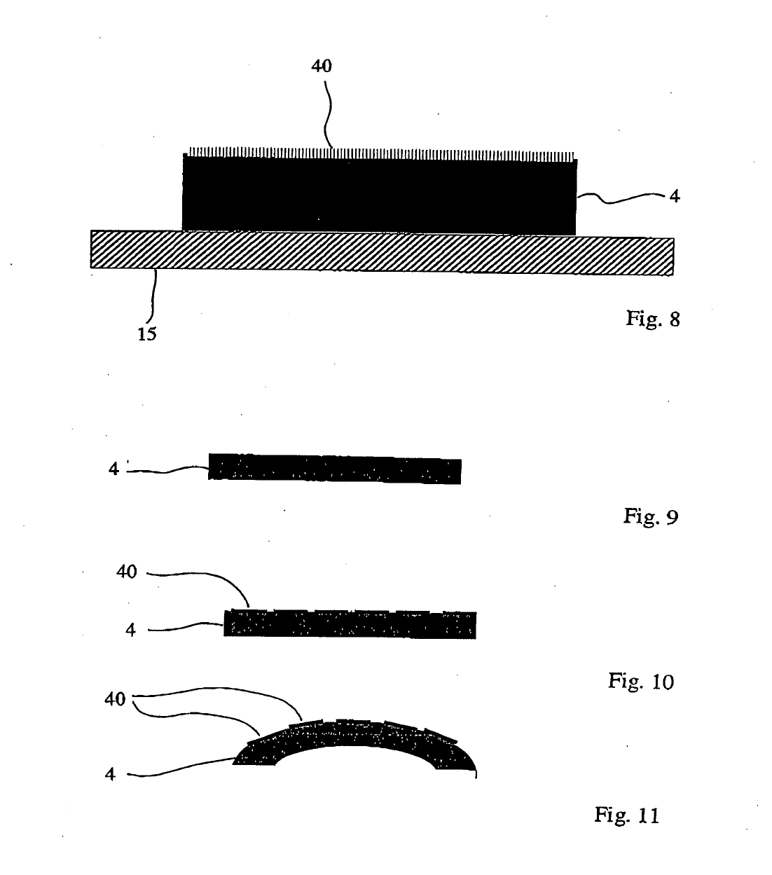

FIG. 8 shows an improved adhesive contact surface 5 in place on, or made of, a flexible material 4 forming a base 10, for example, attached to the flexible plate 15 of the example of FIG. 4. It should be noted that this improved adhesive contact surface 5, which can be applied to all of the examples shown in FIGS. 1 to 7, advantageously includes a fibrillated or laminate microstructure, increasing the adhesive force.

The microstructure 40 includes microlamellas or micropins on the surface, which increase the intensity of the Van de Waals forces in play in the adhesion of surface 5 with surface 2 of the plate 3. The micropins can have a diameter of between 0.1 μm and several dozen micrometers. The microlamellas have thicknesses of the same order. The height of the microlamellas or micropins is between 1 and 200 μm. Such shapes can be obtained in any way known, for example, by lithographic or “nanoinprint” methods. The material constituting the microstructure 40 can, for example, be an intrinsically hard material, as silicon (compatible for a contact with a semiconductor plate) and can be polymerized or stuck to all or a portion of the surface 5 of the flexible material 4 in order to improve the adhesion of the base 10, and the flexible material can be a monomer or polymer-type flexible material, an organic-type flexible material such as PU, PMMA, or silicone PDMS, compatible with the material of the semiconductor plate used in this case. The material forming the microstructure 40 can be, alternatively, the constituent flexible material of the base, at the surface of which the microstructure has been formed.

FIG. 9 shows the section in the thickness of an intrinsically flexible material 4 embodied as a constant thickness layer. FIGS. 10 and 11 show as an alternative, the intrinsically flexible material 4 layer of the FIG. 9 on which an intrinsically hard material has been polymerized, for example a silicon-type material or other, carried out in a microstructure form, for example as described above, in order to confer it a flexible capacity for contacting with the semiconductor plate or wafer. The intrinsically hard material forming a microstructure 40 is made of a plurality of separate parts, each part forming a small surface, such that a discontinuity is ensured between two adjacent parts. This ensures a sufficient extension of the flexible material as a unit thus constituted, for example in view of a possible distortion of the flexible material used, in particular with the seventh embodiment of the invention according to FIGS. 7A to 7D. Indeed, if the microstructure 40 which is made of an intrinsically hard material can, as a whole, show some flexible capacities due to its geometry, such a microstructure generally has no sufficient elastic extension capacity to follow the elastic extension of a flexible layer 4 which is able to significantly become deformed, for example to change a plane shape into a dome shape, as shown in the seventh embodiment according to FIGS. 7A to 7B.

The invention also relates to a system for gripping a glass or semiconductor plate 2 (wafer) or the like, comprising:

a rigid arm 12 for gripping the glass or semiconductor plate (wafer) or the like, having a plurality of degrees of freedom of movement, and

at least three devices for adhesive contact with a surface of the glass or semiconductor plate (wafer) or the like, according to any one of the examples shown in FIGS. 1 to 7, connected to the rigid gripping arm 12.

The rigid arm 12 for gripping a glass or semiconductor plate or the like can be of any known type, for example, any type of flat plate-like element comprising, on a substantially planar surface, at least three devices according to the invention, arranged so as to ensure the static equilibrium of the plate, and a dynamic equilibrium when the plate moves with the arm. The plate-like element will be attached to a robot, giving it, as needed, an appropriate number of degrees of freedom, for example six. A plate is gripped by bringing the plate-like element near a surface of the plate by means of a movement of the plate-like element enabled by the robot, then against the surface of the plate-like element so that the respective adhesive surfaces of the bases of the contact devices adhere to the plate and thus enable the latter to be gripped, then transported in space owing to the degrees of movement of the plate-like element. The device according to the invention allows for rapid movement and high accelerations of the plate in a direction parallel to the contact surface of the bases, regardless of the direction of gravitational pull with respect to the plate. According to the selected embodiment, the device according to the invention can also allow for maximum adhesion in a direction perpendicular to the adhesive contact surface, for example, the embodiment shown in FIG. 7. The other embodiments described can provide excellent adhesion in this perpendicular direction, in every case adequate for the requirements, for example by sizing the contact surface broadly enough for a dry adhesion bonding resistance during the arm acceleration time and with respect to the intensity of a maximum acceleration. The improved adhesive surface of FIG. 8 can also satisfy this requirement.

On a single rigid arm, the devices can be identical or different, depending, for example, on their position and distribution.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A device for contact by adhesion to a plate surface of a plate, the device comprising:
a base including a flexible material equipped with an adhesive contact surface intended to be attached to said plate surface by adhesion; and
means for differentiating the separation resistance between said adhesive contact surface made of the flexible material and the surface of the plate, in a direction perpendicular to the adhesive contact surface and in a direction parallel to said adhesive contact surface.

2. The device according to claim 1, in which the means for differentiating the separation resistance between said adhesive contact surface made of the flexible material and the surface of the plate, in a direction perpendicular to the adhesive contact surface and in a direction parallel to said adhesive contact surface, includes:
means for conferring on the base a stiffness or elastic extension capacity in the direction perpendicular to the adhesive contact surface, differentiated over the width of the base.

3. The device according to claim 1, in which the separation resistance between said adhesive contact surface and the surface of the plate, in a direction perpendicular to the adhesive contact surface, is lower than the separation resistance between said adhesive contact surface and the plate in a direction parallel to said adhesive contact surface.

4. The device according to claim 1, in which said means for differentiating the separation resistance between the adhesive contact surface and the surface of the plate, in a direction perpendicular to the adhesive contact surface and in a direction parallel to said adhesive contact surface, includes:
a rigid material secured to the flexible material, forming therewith a base having a constant or substantially constant thickness, and defining a different thickness of the flexible material over the width of said base or at least a portion thereof.

5. The device according to claim 4, in which the thickness of the flexible material gradually and continuously increases over the width of said base or at least a portion thereof.

6. The device according to claim 4, in which the rigid material adopts a cylindrical shape comprising a biased end, wherein the flexible material is attached to the rigid material by said biased end and adopts a complementary shape so as to confer on the base a right cylinder assembly shape.

7. The device according to claim 4, in which the rigid material adopts a conical shape integrated in the flexible material.

8. The device according to claim 4, in which the rigid material adopts a shape comprising a conical recess in which the flexible material having a complementary conical shape is integrated.

9. The device according to claim 1, in which the flexible material forms the base, and in which said means for differentiating the separation resistance between the adhesive contact surface and the surface of the plate, in a direction perpendicular to the adhesive contact surface and in a direction parallel to said adhesive contact surface, include at least one transverse slot of the base, extending over at least a portion of the transverse cross-section of the flexible material.

10. The device according to claim 9, in which said at least one transverse slot of the base, extends over at least a portion of the transverse cross-section of the flexible material so as to confer a U-structure on the base.

11. The device according to claim 9, in which the base includes two opposing transverse slots, extending over at least a portion of the transverse cross-section of the flexible material, at two different heights thereof so as to confer a flexible Z-structure on the base.

12. The device according to claim 9, in which the base takes the form of a flexible material layer in which a spiral cross sectional slot is formed, providing a spiral flexible material layer the center of which being attached to a support.

13. The device according to claim 1, in which said means for differentiating the separation resistance between the adhesive contact surface and the surface of the plate, in a direction perpendicular to the adhesive contact surface and in a direction parallel to said adhesive contact surface, include:
a flexible plate intended to be attached to a rigid support capable of supporting said plate, on a surface and to an end of which the flexible material is attached, wherein the flexible material forms said base of which a first end constitutes said adhesive contact surface, and of which the other end opposite the first constitutes a surface for bonding to the flexible plate.

14. The device according to claim 1, in which said means for differentiating the separation resistance between the adhesive contact surface and the surface of the plate, in a direction perpendicular to the adhesive contact surface and in a direction parallel to said adhesive contact surface, include:
a rigid support capable of supporting said plate, on a surface and to an end of which the flexible material is attached, wherein the flexible material forms a base of which a first end constitutes said adhesive contact surface, and of which the other end opposite the first includes an annular surface for bonding to the rigid support,
the flexible material adopts a deformable elastic membrane form,
the rigid support comprises a pressurized fluid supply line leading to the annular bonding surface,
means for supplying the line with pressurized fluid, so as to confer at least two distinct positions on the deformable membrane:
a first adhesion position, in the absence of a pressurized fluid supply to the deformable membrane, in which the separation resistance between said adhesive contact surface and the plate surface in a direction parallel to said adhesive contact surface is maximal,
a second separation position, in the presence of a pressurized fluid supply to the deformable membrane, in which the separation resistance between said adhesive contact surface and the plate surface in a direction perpendicular to the adhesive contact surface is minimal.

15. The device according to claim 1, in which said adhesive contact surface made of the flexible material includes a fibrillated or laminate microstructure, increasing the adhesive force.

16. The device according to claim 1, in which said adhesive contact surface consists of a porous or microporous substance, allowing the passage of a gaseous fluid therethrough.

17. A system for gripping a plate, the system comprising:
a rigid arm for gripping the plate, having a plurality of degrees of freedom of movement,
at least three devices for contact by adhesion to a surface of the plate, according to claim 1, connected to said gripping arm.

18. A device for contact by adhesion to a plate surface of a plate, the device comprising:
a base including a flexible material equipped with an adhesive contact surface intended to be attached to said plate surface by adhesion; and
wherein the base is adapted to differentiate the separation resistance between said adhesive contact surface made of the flexible material and the surface of the plate, in a direction perpendicular to the adhesive contact surface and in a direction parallel to said adhesive contact surface.

19. The device according to claim 18
wherein the base has a stiffness or elastic extension capacity in the direction perpendicular to the adhesive contact surface, differentiated over the width of the base.

20. A system for gripping a plate, the system comprising:
a rigid arm for gripping the plate, having a plurality of degrees of freedom of movement,
at least three devices for contact by adhesion to a surface of the plate, according to claim 18, connected to said gripping arm.
